(19) United States
(12) Patent Application Publication
(10) Pub. No.: US 2025/0378830 A1
(43) Pub. Date: Dec. 11, 2025

(54) VOICE ASSISTANT SYSTEM BASED ON PARALINGUISTIC ELEMENT OF INPUT SPEECH

(71) Applicant: QUALCOMM Incorporated, San Diego, CA (US)

(72) Inventors: Tushar AGARWAL, San Diego, CA (US); Ravi SHANKAR, San Diego, CA (US); Vivek RAJENDRAN, San Diego, CA (US); Daniel Jared SINDER, San Diego, CA (US); Ananthapadmanabhan Arasanipalai KANDHADAI, San Diego, CA (US)

(21) Appl. No.: 18/736,331

(22) Filed: Jun. 6, 2024

(51) Int. Cl. G10L 15/22; G10L 15/26

(52) U.S. Cl. CPC G10L 15/22; G10L 15/26; G10L 2015/223

(57) ABSTRACT

Disclosed are techniques for operating a voice assistant system. In an aspect, a large language processing subsystem of the voice assistant system may receive input audio data that corresponds to an input speech. The large language processing subsystem of the voice assistant system may process the input audio data to obtain an input text of the input speech and an input paralinguistic element of the input speech. The large language processing subsystem of the voice assistant system may generate a response based on the input text and the input paralinguistic element of the input speech. The large language processing subsystem of the voice assistant system may convert the response into output audio data that corresponds to an output speech.

### BACKGROUND OF THE DISCLOSURE

### 1. Field of the Disclosure

Aspects of the disclosure relate generally to a voice assistant system.

### 2. Description of the Related Art

Voice assistant systems based on large language models (LLMs) are getting popular in various applications and are usually accessible via user devices, such as mobile and wearable devices and/or smart home devices. In some applications, a voice assistant system based on an LLM may allow a user to ask a question by an input speech and obtain an answer to the question by an output speech in an interactive manner. In some applications, a voice assistant system may receive an input speech from a user's utterance, prepare a response based on the input speech, and then output an audio signal including an output speech based on the response. For example, a user may ask a voice assistant system based on an input speech of “how is the weather.” The voice assistant system may recognize the inquiry embedded in the input speech and prepare a response, e.g., “it is sunny today with a high near 70 degrees and a low near 55 degrees,” which may be output by the voice assistant system as an output speech.

In many applications, a voice assistant system based on an LLM may interact with a user based on an input text obtained from the input speech. However, the input speech may include additional information (or being referred to as the paralinguistic element of the input speech) that is not recognizable as the input text. The paralinguistic element of the input speech may correspond to emotion of the user, expressions of the user, or even background noise where the user utter the input speech. An existing LLM may derive a response based on the input text of the input speech, but may not consider the paralinguistic element of the input speech.

Accordingly, there is a need for an improved voice assistant system and method of operating the system that would consider the input text of the input speech as well as the paralinguistic element of the input speech in order to provide a user experience more closely resembling talking to a real person.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a voice assistant system includes one or more processing devices configured to: receive input audio data that corresponds to an input speech; and process the input audio data to obtain an input text of the input speech and an input paralinguistic element of the input speech; and a large language processing subsystem configured to: generate a response based on the input text and the input paralinguistic element of the input speech, wherein the one or more processing devices are further configured to: convert the response into output audio data that corresponds to an output speech.

In an aspect, a method of operating a voice assistant system on one or more processing devices includes receiving input audio data that corresponds to an input speech; processing the input audio data to obtain an input text of the input speech and an input paralinguistic element of the input speech; generating, by a large language processing subsystem of the voice assistant system, a response based on the input text and the input paralinguistic element of the input speech; and converting the response into output audio data that corresponds to an output speech.

In an aspect, a voice assistant system includes means for receiving input audio data that corresponds to an input speech; means for processing the input audio data to obtain an input text of the input speech and an input paralinguistic element of the input speech; means for generating a response based on the input text and the input paralinguistic element of the input speech; and means for converting the response into output audio data that corresponds to an output speech.

In an aspect, a non-transitory computer-readable medium stores computer-executable instructions that, when executed by a voice assistant system, cause the voice assistant system to: receive input audio data that corresponds to an input speech; process the input audio data to obtain an input text of the input speech and an input paralinguistic element of the input speech; generate a response based on the input text and the input paralinguistic element of the input speech; and convert the response into output audio data that corresponds to an output speech.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A and 2B are simplified block diagrams of several sample aspects of components that may be employed in a user equipment (UE) and a server device, respectively, and configured to support operations as taught herein.

FIG. 3 illustrates a simplified functional block diagram of an example voice assistant system, according to aspects of the disclosure.

FIGS. 4A-4F illustrate simplified functional block diagrams of example variations based on the voice assistant system in FIG. 3, according to aspects of the disclosure.

FIG. 5 illustrates a simplified functional block diagram of an example expression controller, according to aspects of the disclosure.

FIG. 6 is a flowchart illustrating a method of operating a voice assistant system, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to a voice assistant system. Some aspects more specifically relate to a voice assistant system that can generate a response by applying a large language model of a voice assistant system on at least an input text of an input speech and an input paralinguistic element (e.g., mood, emotion, or intent) of the input speech. In some examples, the response may include an output text of an output speech and information corresponding to an output paralinguistic element (e.g., expression, emotion, or tone) of the output speech.

According to one or more aspects of this disclosure, a virtual agent or an expressive virtual artificial intelligent (AI) assistant implemented based on this disclosure may be less susceptible to personal emotions affecting professional interactions in contrast to a human assistant. According to one or more aspects of this disclosure, a virtual agent or an expressive virtual AI assistant implemented based on this disclosure may provide services on a 24/7 basis. In some aspects, voice assistants may have much broader practical use cases than other forms of AI assistants. For example, while a user is performing physically engaging activities like driving, a preferred way to safely interact with an assistant may be through voice. Having such an expressive assistant can provide proper assistance at a proper time with the least amount of distraction.

In some aspects, the present disclosure corresponds to integrating a pre-trained large language model (LLM) with the ability to use additional information from the surrounding environment and user-specific knowledge to generate text output in a first-person dialogue format. The speech output may further drive a virtual assistant in a visual setting. In some examples, an exemplary system according to the present disclosure may combine an automatic speech recognition (ASR) model with a plain text based LLM and an expressive text-to-speech (TTS) model. In some examples, additional information that can be used for fine-tuning the LLM or can be used by the LLM may include: (a) speakers emotional and mental state (prosody and language); (b) health vitals (heart rate, breathing rate, stress level, etc. from a smart watch); (c) background noise (busy street/railway station/airport/theatre etc.); (d) location and time; (e) emails, calendars, and contacts; (f) and a continuously updating speaker profile representation. In some aspects, the generated text output and a predicted target emotional state representation may serve as additional inputs to ultimately aid a speech synthesizer and avatar generator to have natural-sound and natural-appearing emotion and expression.

Particular aspects of the subject matter described in this disclosure can be implemented to realize one or more of the following potential advantages. In some aspects, one benefit of the present disclosure may correspond to the development of a virtual assistant that integrates seamlessly with an LLM model and reacts to more than just textual information. It may be further implemented as a multi-purpose audio-visual assistant for a complete interaction experience. It can make the conversational AI systems adaptable to different situations depending on one or more factors such as whispering speech when the user is in a conference room or theatre (e.g., determined via location, time, and calendar). Another potential use case is synthesizing or generating spatially aware speech from users surrounding information (e.g., via background noise/location) for a simulated experience of talking to someone in the same environment.

In some aspects, one benefit of the present disclosure may correspond to giving the user the ability to control the expressiveness of a virtual assistant. In some aspects according to the present disclosure, a controller that can take human-interpretable inputs from the user e.g., scalar amplitudes, expected assistant behavior, etc., may be introduced. These user inputs may be then used to manipulate corresponding emotion embeddings consequently controlling the virtual assistant's expressions. The control inside this emotion controller can be a mix of relative or absolute control. Relative control may correspond to modifying the embedding of the emotional interpreter while absolute control will sample a new emotion embedding given the assistants expected behavior. Accordingly, a user may have more control over the virtual assistant's expressiveness and have the virtual assistant tailored for different situations as needed.

In some examples, by considering the input paralinguistic element of the input speech and generating the response including the output paralinguistic element of the output speech, the described techniques can be used to provide a user of the voice assistant system the enhanced experiences of interacting with the voice assistant system as if the user is interacting with an virtual agent resembling the experiences of talking to a real person.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof.

Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

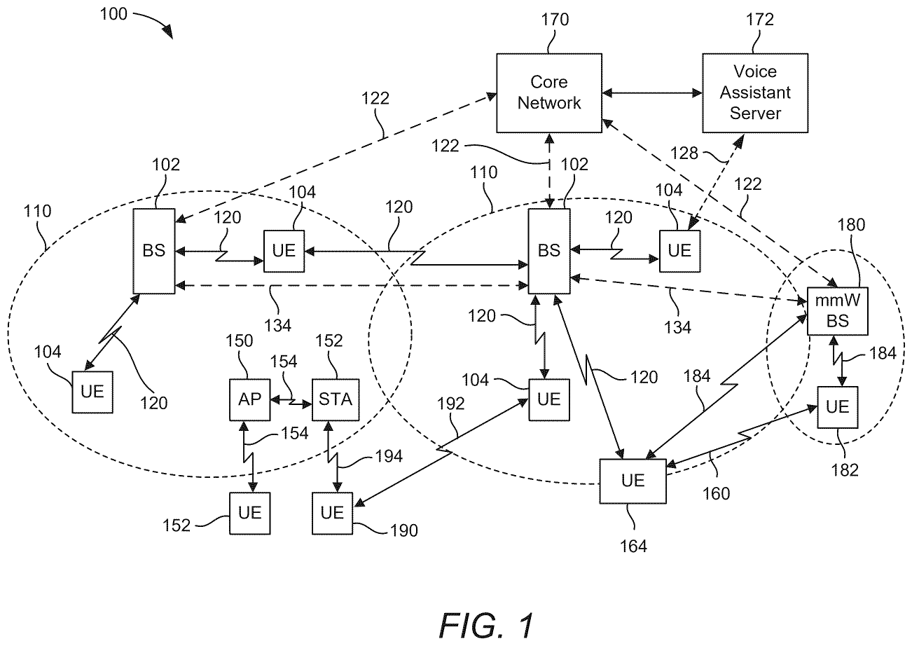

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more servers 172 (e.g., a voice assistant server). In some aspects, the voice assistant server 172 may be configured to work with a UE (e.g., any UE show in FIG. 1) to implement a voice assistant system accessible to a user of the UE. In some aspects, a UE alone (e.g., any UE show in FIG. 1) may be configured to implement a voice assistant system accessible to a user of the UE.

The voice assistant server 172 may be part of core network 170 or may be external to core network 170. In some aspects, the voice assistant server 172 may be integrated with a base station 102, or even a UE, or any combination of a server device, a bases station, and/or a UE. A UE 104 may communicate with a voice assistant server 172 directly or indirectly. For example, a UE 104 may communicate with a voice assistant server 172 via the base station 102 that is currently serving that UE 104. A UE 104 may also communicate with a voice assistant server 172 through another path, such as via an application server (not shown), via another network, such as via a wireless local area network (WLAN) access point (AP) (e.g., AP 150 described below), and so on. For signaling purposes, communication between a UE 104 and a voice assistant server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHZ). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

The electromagnetic spectrum is often subdivided, based on frequency/wavelength, into various classes, bands, channels, etc. In 5G NR two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the INTERNATIONAL TELECOMMUNICATION UNION® as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102. Note that although FIG. 1 only illustrates some of the UEs as SL-UEs (i.e., UEs 164 and 182), any of the illustrated UEs may be SL-UEs.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WI-FI DIRECT®, BLUETOOTH®, and so on.

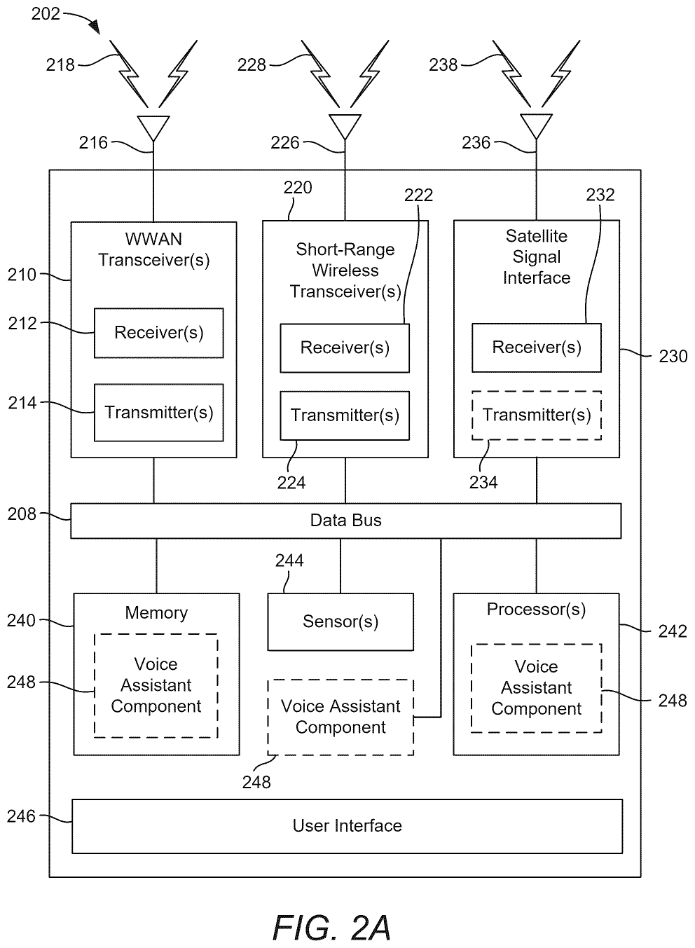

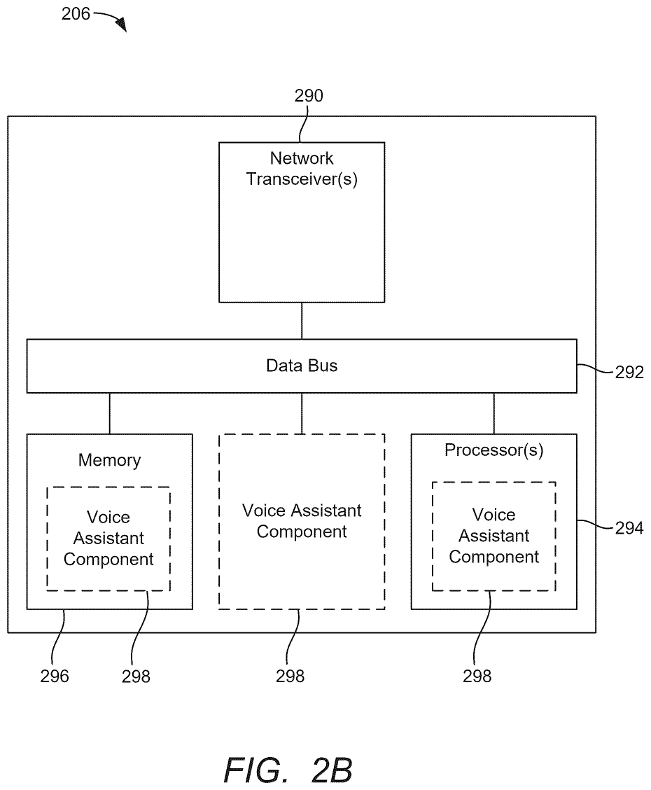

FIGS. 2A and 2B illustrate several example components (represented by corresponding blocks) that may be incorporated into a UE 202 (which may correspond to any of the UEs described herein) and a server device 206 (which may correspond to the voice assistant server 172 in FIG. 1) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 202 may include one or more wireless wide area network (WWAN) transceivers 210 providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 210 may be connected to one or more antennas 216 for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 210 may be variously configured for transmitting and encoding signals 218 (e.g., messages, indications, information, and so on), and, conversely, for receiving and decoding signals 218 (e.g., messages, indications, information, pilots, and so on), in accordance with the designated RAT. Specifically, the WWAN transceivers 210 include one or more transmitters 214 for transmitting and encoding signals 218, and one or more receivers 212 for receiving and decoding signals 218.

The UE 202 may also include, at least in some cases, one or more short-range wireless transceivers 220. The short-range wireless transceivers 220 may be connected to one or more antennas 226, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE Direct, BLUETOOTH®, ZIGBEE®, Z-WAVE®, PC5, dedicated short-range communications (DSRC), wireless access for vehicular environments (WAVE), near-field communication (NFC), ultra-wideband (UWB), etc.) over a wireless communication medium of interest. The short-range wireless transceivers 220 may be variously configured for transmitting and encoding signals 228 (e.g., messages, indications, information, and so on), and, conversely, for receiving and decoding signals 228 (e.g., messages, indications, information, pilots, and so on), in accordance with the designated RAT. Specifically, the short-range wireless transceivers 220 include one or more transmitters 224 for transmitting and encoding signals 228, and one or more receivers 222 for receiving and decoding signals 228. As specific examples, the short-range wireless transceivers 220 may be Wi-Fi transceivers, BLUETOOTH® transceivers, ZIGBEE® and/or Z-WAVE® transceivers, NFC transceivers, UWB transceivers, or vehicle-to-vehicle (V2V) and/or vehicle-to-everything (V2X) transceivers.

The UE 202 may also include, at least in some cases, satellite signal interfaces 230, which may include one or more satellite signal receivers 232, and may optionally include one or more satellite signal transmitters 234. The satellite signal receivers 232 may be connected to one or more antennas 236, and may provide means for receiving and/or measuring satellite positioning/communication signals 238. Where the satellite signal receiver(s) 232 may be satellite positioning system receivers, the satellite positioning/communication signals 238 may be global positioning system (GPS) signals, global navigation satellite system (GLONASS) signals, Galileo signals, Beidou signals, Indian Regional Navigation Satellite System (NAVIC), Quasi-Zenith Satellite System (QZSS) signals, etc. Where the satellite signal receiver(s) 232 may be non-terrestrial network (NTN) receivers, the satellite positioning/communication signals 238 may be communication signals (e.g., carrying control and/or user data) originating from a 5G network. The satellite signal receiver(s) 232 may comprise any suitable hardware and/or software for receiving and processing satellite positioning/communication signals 238. The satellite signal receiver(s) 232 may request information and operations as appropriate from the other systems, and, at least in some cases, perform calculations to determine locations of the UE 202 using measurements obtained by any suitable satellite positioning system algorithm.

The optional satellite signal transmitter(s) 234, when present, may be connected to the one or more antennas 236, and may provide means for transmitting satellite positioning/communication signals 238. Where the satellite signal transmitter(s) 234 may be NTN transmitters, the satellite positioning/communication signals 238 may be communication signals (e.g., carrying control and/or user data) originating from a 5G network. The satellite signal transmitter(s) 234 may comprise any suitable hardware and/or software for transmitting satellite positioning/communication signals 238. The satellite signal transmitter(s) 234 may request information and operations as appropriate from the other systems.

The server device 206 may include one or more network transceivers 280 providing means for communicating (e.g., means for transmitting, means for receiving, etc.) with other network entities. For example, the server device 206 may employ the one or more network transceivers 290 to communicate with one or more base stations (e.g., any base stations describe herein) over one or more wired or wireless backhaul links, or with other server device(s) 206 over one or more wired or wireless core network interfaces.

A transceiver may be configured to communicate over a wired or wireless link. A transceiver (whether a wired transceiver or a wireless transceiver) includes transmitter circuitry (e.g., transmitters 214, 224) and receiver circuitry (e.g., receivers 212, 222). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 290 in some implementations) may be coupled to one or more wired network interface ports. Wireless transmitter circuitry (e.g., transmitters 214, 224) may include or be coupled to a plurality of antennas (e.g., antennas 216, 226), such as an antenna array, that permits the respective apparatus (e.g., UE 202) to perform transmit “beamforming,” as described herein. Similarly, wireless receiver circuitry (e.g., receivers 212, 222) may include or be coupled to a plurality of antennas (e.g., antennas 216, 226), such as an antenna array, that permits the respective apparatus (e.g., UE 202) to perform receive beamforming, as described herein. In an aspect, the transmitter circuitry and receiver circuitry may share the same plurality of antennas (e.g., antennas 216, 226), such that the respective apparatus can only receive or transmit at a given time, not both at the same time. A wireless transceiver (e.g., WWAN transceivers 210, short-range wireless transceivers 220) may also include a network listen module (NLM) or the like for performing various measurements.

As used herein, the various wireless transceivers (e.g., transceivers 210, 220, and network transceivers 290 in some implementations) and wired transceivers (e.g., network transceivers 290 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or server devices will generally relate to signaling via a wired transceiver, whereas wireless communication between a UE (e.g., UE 202) and a base station will generally relate to signaling via a wireless transceiver.

The UE 202 and the server device 206 also include other components that may be used in conjunction with the operations as disclosed herein. The UE 202 and the server device 206 include one or more processors 242 and 294, respectively, for providing functionality relating to, for example, wireless communication, and for providing other processing functionality. The processors 242 and 294 may therefore provide means for processing, such as means for determining, means for calculating, means for receiving, means for transmitting, means for indicating, etc. In an aspect, the processors 242 and 294 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 202 and the server device 206 include memory circuitry implementing memories 240 and 296 (e.g., each including a memory device), respectively, for maintaining information (e.g., information indicative of reserved resources, thresholds, parameters, and so on). The memories 240 and 296 may therefore provide means for storing, means for retrieving, means for maintaining, etc. In some cases, the UE 202 and the server device 206 may include voice assistant components 248 and 298, respectively. The voice assistant components 248 and 298 may be hardware circuits that are part of or coupled to the processors 242 and 294, respectively, that, when operated, cause the UE 202 and the server device 206 to perform the functionality described herein. In other aspects, the voice assistant components 248 and 298 may be external to the processors 242 and 294 (e.g., part of a modem processing system, integrated with another processing system, etc.). Alternatively, the voice assistant components 248 and 298 may be memory modules stored in the memories 240 and 296, respectively (e.g., non-transitory memories storing computer-readable instructions), that, when executed by the processors 242 and 294 (or a modem processing system, another processing system, etc.), cause the UE 202 and the server device 206 to perform the functionality described herein. FIG. 2A illustrates possible locations of the voice assistant component 248, which may be, for example, part of the memory 240, the one or more processors 242, or any combination thereof, or may be a standalone component. FIG. 2B illustrates possible locations of the Voice Assistant Component 298, which may be, for example, part of the memory 296, the one or more processors 294, or any combination thereof, or may be a standalone component.

The UE 202 may include one or more sensors 244 coupled to the one or more processors 242 to provide means for sensing or detecting movement and/or orientation information that is independent of motion data derived from signals received by the one or more WWAN transceivers 210, the one or more short-range wireless transceivers 220, and/or the satellite signal interface 230. By way of example, the sensor(s) 244 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 244 may include a plurality of different types of devices and combine their outputs in order to provide motion information. For example, the sensor(s) 244 may use a combination of a multi-axis accelerometer and orientation sensors to provide the ability to compute positions in two-dimensional (2D) and/or three-dimensional (3D) coordinate systems.

In addition, the UE 202 includes a user interface 246 providing means for providing indications (e.g., audible and/or visual indications) to a user and/or for receiving user input (e.g., upon user actuation of a sensing device such a keypad, a touch screen, a microphone, and so on). Although not shown, the server device 206 may also include a corresponding user interface.

At the UE 202, the receiver 212 receives a signal through its respective antenna(s) 216. The receiver 212 recovers information modulated onto an RF carrier and provides the information to the one or more processors 242. The transmitter 214 and the receiver 212 implement Layer-1 functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The receiver 212 may perform spatial processing on the information to recover any spatial streams destined for the UE 202. If multiple spatial streams are destined for the UE 202, they may be combined by the receiver 212 into a single orthogonal frequency division multiplexing (OFDM) symbol stream. The receiver 212 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 204. These soft decisions may be based on channel estimates computed by a channel estimator. The soft decisions are then decoded and de-interleaved to recover the data and control signals that were originally transmitted by the base station 204 on the physical channel. The data and control signals are then provided to the one or more processors 242, which implements Layer-3 (L3) and Layer-2 (L2) functionality.

In the downlink, the one or more processors 242 provides demultiplexing between transport and logical channels, packet reassembly, deciphering, header decompression, and control signal processing to recover IP packets from the core network. The one or more processors 242 are also responsible for error detection.

In some aspects, the one or more processors 242 provides radio resource control (RRC) layer functionality associated with system information (e.g., master information block (MIB), system information blocks (SIBs)) acquisition, RRC connections, and measurement reporting; packet data convergence protocol (PDCP) layer functionality associated with header compression/decompression, and security (ciphering, deciphering, integrity protection, integrity verification); radio link control (RLC) layer functionality associated with the transfer of upper layer protocol data units (PDUs), error correction through automatic repeat request (ARQ), concatenation, segmentation, and reassembly of RLC service data units (SDUs), re-segmentation of RLC data PDUs, and reordering of RLC data PDUs; and medium access control (MAC) layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 204 may be used by the transmitter 214 to select the appropriate coding and modulation schemes, and to facilitate spatial processing. The spatial streams generated by the transmitter 214 may be provided to different antenna(s) 216. The transmitter 214 may modulate an RF carrier with a respective spatial stream for transmission.

For convenience, the UE 202 and/or the server device 206 are shown in FIGS. 2A and 2B as including various components that may be configured according to the various examples described herein. It will be appreciated, however, that the illustrated components may have different functionality in different designs. In particular, various components in FIGS. 2A and 2B are optional in alternative configurations and the various aspects include configurations that may vary due to design choice, costs, use of the device, or other considerations. For example, in case of FIG. 2A, a particular implementation of UE 202 may omit the WWAN transceiver(s) 210 (e.g., a wearable device or tablet computer or personal computer (PC) or laptop may have Wi-Fi and/or BLUETOOTH® capability without cellular capability), or may omit the short-range wireless transceiver(s) 220 (e.g., cellular-only, etc.), or may omit the satellite signal interface 230, or may omit the sensor(s) 244, and so on. For brevity, illustration of the various alternative configurations is not provided herein, but would be readily understandable to one skilled in the art.

The various components of the UE 202 and the server device 206 may be communicatively coupled to each other over data buses 208 and 292, respectively. In an aspect, the data buses 208 and 292 may form, or be part of, a communication interface of the UE 202 and the server device 206, respectively. For example, where different logical entities are embodied in the same device, the data buses 208 and 292 may provide communication between them.

The components of FIGS. 2A and 2B may be implemented in various ways. In some implementations, the components of FIGS. 2A and 2B may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 210 to 246 may be implemented by processor and memory component(s) of the UE 202 (e.g., by execution of appropriate code and/or by appropriate configuration of processor components). Similarly, some or all of the functionality represented by blocks 290 to 298 may be implemented by processor and memory component(s) of the server device 206 (e.g., by execution of appropriate code and/or by appropriate configuration of processor components). For simplicity, various operations, acts, and/or functions are described herein as being performed “by a UE,” and/or “by a server device,” etc. However, as will be appreciated, such operations, acts, and/or functions may actually be performed by specific components or combinations of components of the UE 202 and/or server device 206, etc., such as the processors 242 and 294, the transceivers 210, 220, the memories 240 and 296, the voice assistant components 248 and 298, etc.

In some designs, the server device 206 may be implemented as a core network component. In other designs, the server device 206 may be distinct from a network operator or operation of the cellular network infrastructure. For example, the server device 206 may be a component of a private network that may be configured to communicate with the UE 202 via a corresponding base station or independently from the base station (e.g., over a non-cellular communication link, such as Wi-Fi).

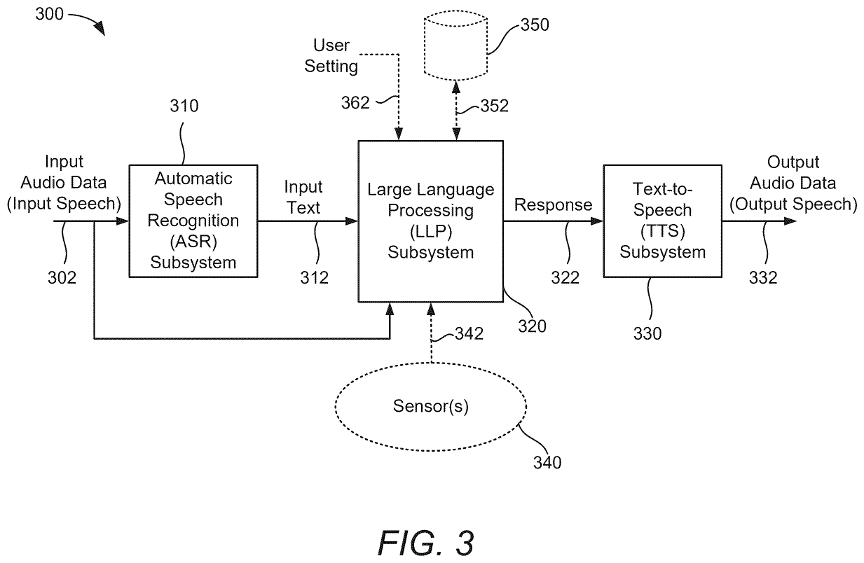

FIG. 3 illustrates a simplified functional block diagram of an example voice assistant system 300, according to aspects of the disclosure. In some aspects, the voice assistant system 300 may be implemented based on a combination of various components and may be implemented based on one or more processing devices including the various components. In some aspects, the voice assistant system 300 may be implemented based on a UE alone (e.g., any of the UEs in FIG. 1, the UE 202 in FIG. 2A, or any UE described in the present disclosure) or a combination of a UE and a voice assistant server (e.g., the voice assistant server 172 in FIG. 1, the server device 206 in FIG. 2B, or any server device described in the present disclosure).

As shown in FIG. 3, the voice assistant system 300 may include an automatic speech recognition (ASR) subsystem 310, a large language processing (LLP) subsystem 320, and a text-to-speech (TTS) subsystem 330. In some aspects, the ASR subsystem 310 may receive input audio data 302 that corresponds to an input speech of a user. In some aspects, the input audio data 302 may be from an audio sensor (e.g., a microphone) of a UE, such as one of the sensors 244 of the UE 202 in FIG. 2A. In some aspects, the ASR subsystem 310 may process the input audio data 302 to obtain an input text 312 of the input speech. In some aspects, the ASR subsystem 310 may output the input text 312 of the input speech to the LLP subsystem 320.

In some aspects, the LLP subsystem 320 may receive the input text 312 of the input speech from the ASR subsystem 310 and may receive the input audio data 302. In some aspects, the LLP subsystem 320 may process at least the input audio data 302 to obtain an input paralinguistic element of the input speech. In some aspects, the LLP subsystem 320 may generate a response 322 based on at least the input text 312 and the input paralinguistic element of the input speech. In some aspects, the LLP subsystem 320 may obtain one or more input paralinguistic parameters representing the input paralinguistic element of the input speech. In some aspects, the response 322 may include at least an output text of an output speech and one or more output paralinguistic parameters representing an output paralinguistic element of the output speech.

In some aspects, the one or more input paralinguistic parameters may indicate the user's mood, emotion, and/or intent that may be detectable from the input audio data 302. In some aspects, the one or more input paralinguistic parameters may further indicate a noise level of a space where the user locates and/or a stress/relax level of the space may cause, or any information that may be detectable from the input audio data 302. In some aspects, the one or more input paralinguistic parameters may be used to save the time or energy for the user to provide information regarding the situational awareness by verbose input via the input speech.

In some aspects, based on the one or more input paralinguistic parameters, the LLP subsystem 320 may determine if the user is angry, happy, in high or low spirits, looking for a short answer, looking for a longer chat, an expected level of detail in the response, or the like. In some aspects, the LLP subsystem 320 may prepare the basic content of the output speech based on the input text of the input speech. In some aspects, the LLP subsystem 320, based on the input paralinguistic element of the input speech and the basic content of the output speech, may prepare the response 322. In some aspects, for the same basic content, the resulting response may still vary in view of the input paralinguistic element in many aspects, including the length of the response, the level of detail, the language style of the output text (e.g., straightforward, diplomatic, humorous, encouraging, lecturing), and/or a tone or emotion to be embedded in the output speech.

In some aspects, the TTS subsystem 330 may receive the response 322 from the LLP subsystem 320 and may convert the response 322 into output audio data 332 that corresponds to the output speech. In some aspects, the output audio based on the output audio data 332 may provide the user the experience or impression that the user is interacting with a virtual agent resembling a human agent.

In some aspects, the voice assistant system 300 may be communicatively coupled to one or more sensors 340 (other than the audio sensor for picking up the input speech, (e.g., from an audio sensor such as a microphone of the voice assistant system, which may correspond to part of the sensors 244 of the UE 202 in FIG. 2A or other sensors not in the UE 202). In some aspects, the voice assistant system 300 may receive one or more sensory inputs 342 from the one or more sensors 340. In some aspects, the LLP subsystem 320 may prepare the response 322 further based on the one or more sensory inputs 342.

In some aspects, the one or more sensors 340 may be disposed in a processing device (e.g., a UE or a wearable device) that is operated by the user and including the audio sensor configured to convert an audio signal into the input audio data 302, an IoT device or another processing device in the space where the user locates, a server device that is configured to implement a portion of all of the LLP subsystem 320, or any combination thereof. In some aspects, the one or more sensory inputs 342 may indicate a location of the user uttering the input speech, a time of utterance of the input speech, a temperature of the space, a weather of the space, a heart rate of the user, a breathing rate of the user, a stress level of the user, or any combination thereof.

In some aspects, the voice assistant system 300 may be communicatively coupled to a database 350. In some aspects, the voice assistant system 300 may receive a user profile 352 from the database 350 and/or may update the user profile 352 stored in the database 350. In some aspects, the voice assistant system 300 may further receive a user setting 362 based on a user operation of the one or more processing devices for implementing the voice assistant system 300. In some aspects, the LLP subsystem 320 may prepare the response 322 further based on the user profile 352 and/or the user setting 362. In some aspects, the user profile 352 and/or the user setting 362 may indicate how the user would like the LLP subsystem 320 to prepare the response 322 based on the input paralinguistic element of the input speech and/or the one or more sensory inputs 342. For example, the LLP subsystem 320 may prepare the response 322 to express the basic content of the output speech with a more or less encouraging, exciting, calm, compassionate, teasing, or the like, tone based on the one or more input paralinguistic parameters, the user setting 362, the user profile 352, the one or more sensory inputs 342, or any combination thereof.

In some aspects, the LLP subsystem 320 may learn the use profile 352 of the user over time. In some aspects, based on a set of enrollment questions, together with the conversations and/or sessions over time, the LLP subsystem 320 may obtain the user profile 352 based on training (or machine learning) a model to gain an understanding of the context and/or background that could be used to complement a simple or terse query. In some aspects, the model of the user profile 352 may be updated in a smooth manner (e.g., slowly updating based on exponential moving average).

In some aspects, in a case that the voice assistant system 300 is configured as an artificial intelligent (AI) secretary, the set of enrollment questions may be used to obtain the information regarding work priorities or key people. In some aspects, in a case that the voice assistant system 300 is configured as an AI physical trainer, the set of enrollment questions may be used to obtain the information regarding history of injuries or workouts to be focused on.

In some aspects, the voice assistant system 300 may be configured as an AI agent, and the information regarding emotion, expression, and/or situational awareness may be relied upon to guide the AI agent on what to say, and when and how to say it. In one example, if the user has a shivering voice, the AI agent may respond in a worried voice. In another example, if the user is in a theatre or a conference hall (e.g., based on the location of the user), the AI agent may respond by whispering or in a low voice. In some aspects, the AI agent may respond with smile if the user is being silly.

In some aspects, based on the user profile 352, the voice assistant system 300 configured as an AI agent may be able to adapt to different scenarios and seamlessly bring in elements of human behavior depending on the situation and/or user's query. In one example, based on the user profile 352, the voice assistant system 300 may be configured as an AI assistant, and the LLP subsystem 320 may be configured to prepare the response 322 based on the basic content that is related to work, errand, or recommendation (music or movie recommendations depending on current time and/or situation). In one example, based on the user profile 352, the voice assistant system 300 may be configured as a coach or mentor, and the LLP subsystem 320 may be configured to prepare the response 322 based on a first coaching mode. In one example, based on the user profile 352, the voice assistant system 300 may be configured as a physical trainer, and the LLP subsystem 320 may be configured to prepare the response 322 based on a second coaching mode. In one example, based on the user profile 352, the voice assistant system 300 may be configured as a weight loss coach, and the LLP subsystem 320 may be configured to prepare the response 322 based on a third coaching mode (e.g., knowing your cheat days, making suggestions on what to eat and/or what not to eat today). In one example, based on the user profile 352, the voice assistant system 300 may be configured as a tutor, and the LLP subsystem 320 may be configured to prepare the response 322 based on a lecturing mode. In one example, based on the user profile 352, the voice assistant system 300 may be configured as a weight loss coach, and the LLP subsystem 320 may be configured to prepare the response 322 based on a casual chit-chat mode.

In some aspects, based on the input text of the input speech as well as the input paralinguistic element of the input speech, the voice assistant system 300 may prepare the response 322 and eventually the output (e.g., the output audio data 332) such that the experiences of interacting with a virtual agent may more closely resemble the experiences of interacting with a human agent.

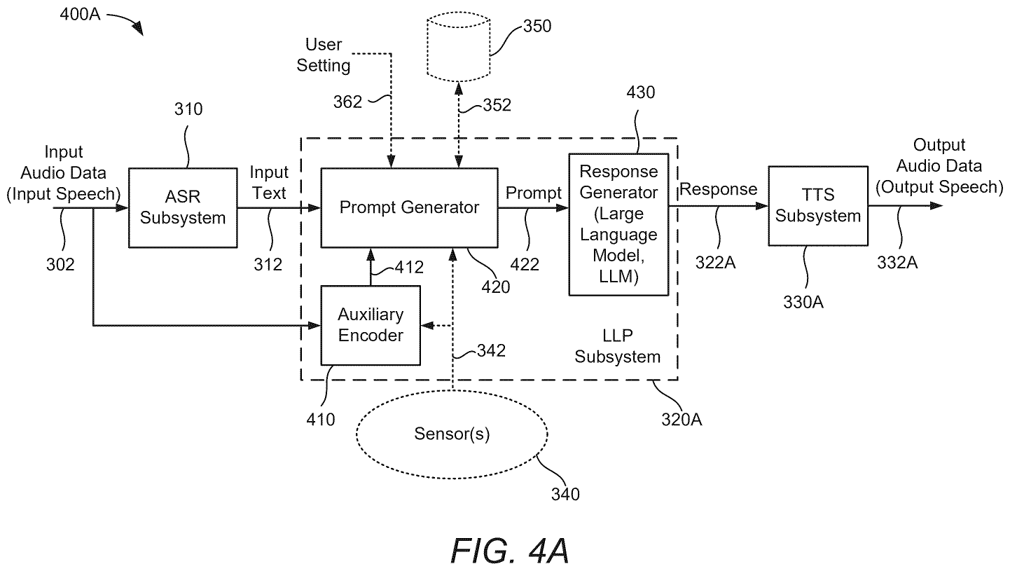

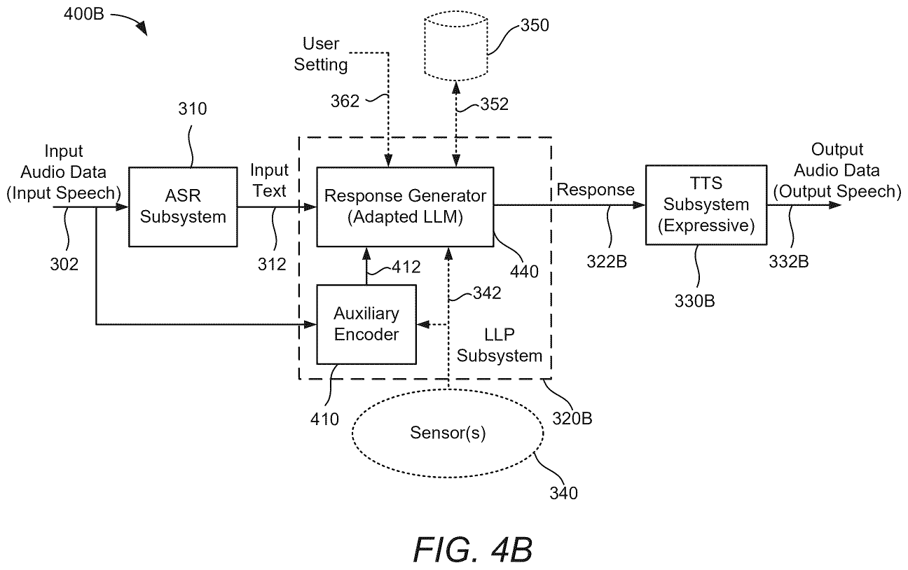

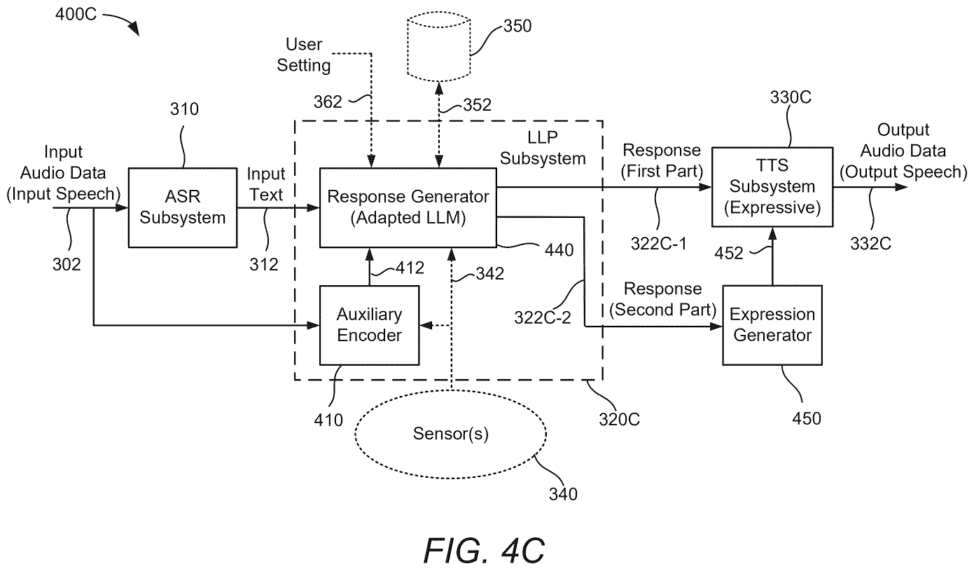

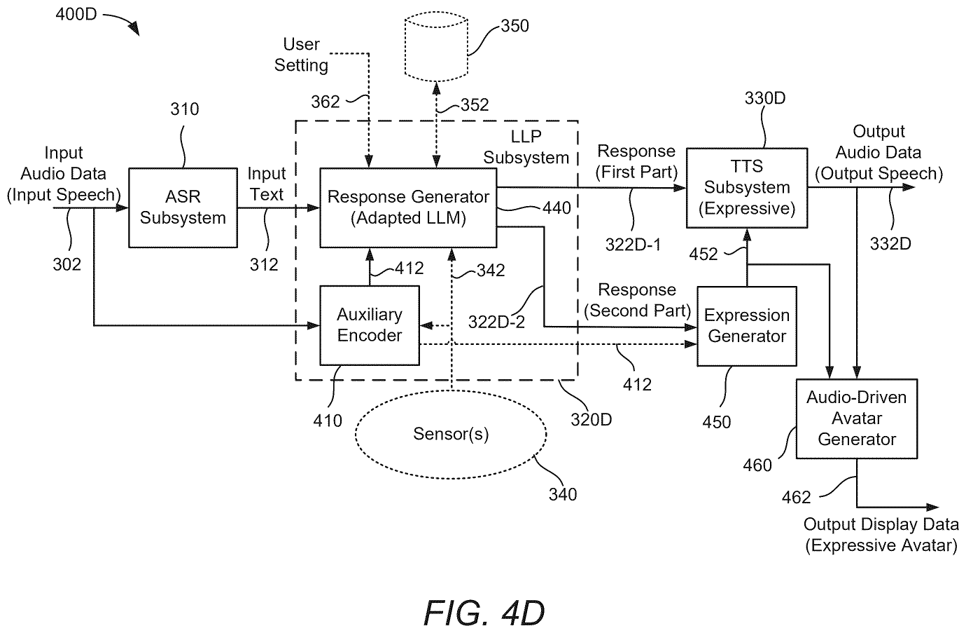

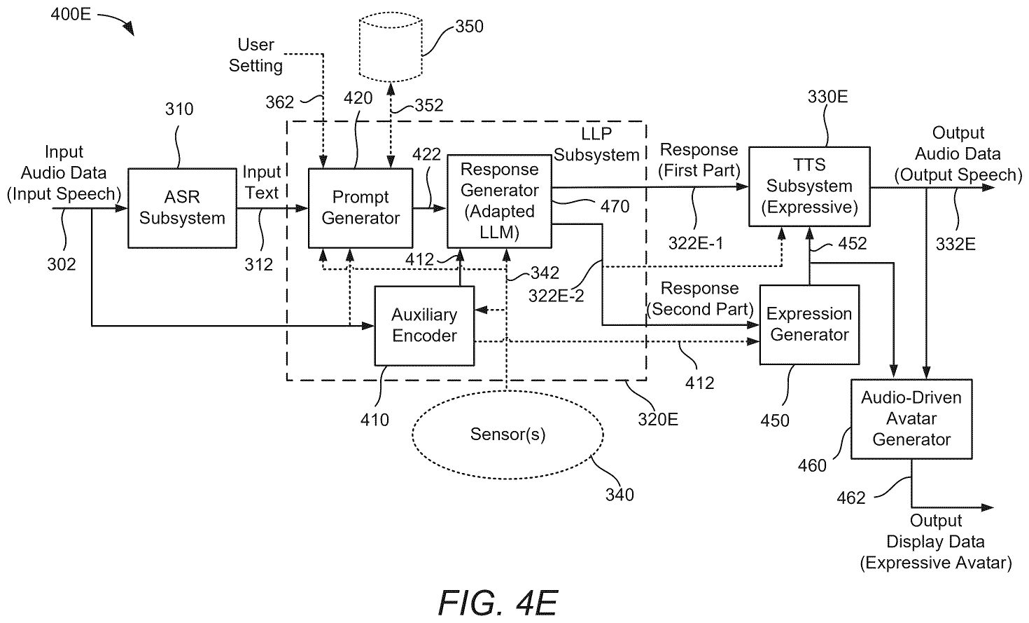

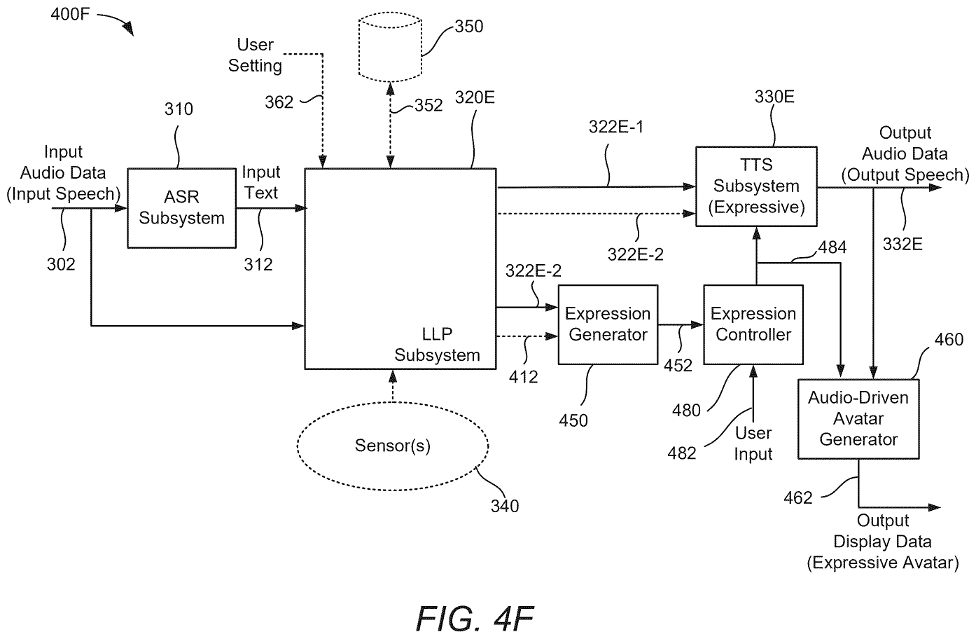

FIG. 4A illustrates a simplified functional block diagram of a first example variation 400A based on the voice assistant system 300 in FIG. 3, according to aspects of the disclosure. In some aspects, the components of the first example variation 400A in FIG. 4A that are the same or similar to those of the voice assistant system 300 in FIG. 3 are given the same reference numbers, and detailed description thereof may be simplified or omitted.

As shown in FIG. 4A, the first example variation 400A may include an LLP subsystem 320A that corresponds to the LLP subsystem 320 in FIG. 3, and a TTS subsystem 330A that corresponds to the TTS subsystem 330 in FIG. 3. As shown in FIG. 4A, the LLP subsystem 320A of the first example variation 400A may include an auxiliary encoder 410, a prompt generator 420, and a response generator 430. In some aspects, the auxiliary encoder 410 may extract and output the input paralinguistic element of the input speech to the prompt generator 420. In some aspects, the auxiliary encoder 410 may receive the input audio data 302 (e.g., from an audio sensor such as a microphone of the voice assistant system, which may correspond to part of the sensors 244 of the UE 202 in FIG. 2A) and may process at least the input audio data 302 to obtain one or more input paralinguistic parameters 412 representing the input paralinguistic element of the input speech. In some aspects, the one or more input paralinguistic parameters 412 may be obtained further based on the one or more sensory inputs 342 from the one or more sensors 340 (which may correspond to part of the sensors 244 of the UE 202 in FIG. 2A or other sensors not in the UE 202).

In some aspects, the prompt generator 420 may generate a prompt 422 based on the input text 312 and the one or more input paralinguistic parameters 412. In some aspects, the prompt 422 may be generated by the prompt generator 420 further based on the user setting 362, the user profile 352, the one or more sensory inputs 342, or any combination thereof. In some aspects, the voice assistant system may further include a user interface (e.g., a keyboard, which may correspond to the user interface 246 of the UE 202 in FIG. 2A.) configured to obtain the user profile. In some aspects, the prompt 422 may be in the form of natural language or text, and may include the input text 312 and one or more descriptions regarding operations or settings of the response generator 430 based on the input paralinguistic element of the input speech and/or additional or other information based on the user setting 362, the user profile 352, and/or the one or more sensory inputs 342. In some aspects, the prompt generator 420 may include a learning logic or a machine learning model that may learn the user's preferences over time. In some aspects, the voice assistant system may further include a user interface (e.g., a display, which may correspond to the user interface 246 of the UE 202 in FIG. 2A.) configured to display the prompt 422 generated by the prompt generator 420.

In some aspects, the response generator 430 may apply a large language model (LLM) of the LLP subsystem 320A on at least the prompt 422 in order to output a response 322A. In some aspects according to the first example variation 400A, the response 322A may include at least an output text of the output speech. The TTS subsystem 330A may convert the response 322A into the output audio data 332A that corresponds to an output speech of a virtual agent (e.g., as the voice assistant system being configured as an AI agent, a coach, a tutor, etc.).

FIG. 4B illustrates a simplified functional block diagram of a second example variation 400B based on the voice assistant system 300 in FIG. 3, according to aspects of the disclosure. In some aspects, the components of the second example variation 400B in FIG. 4B that are the same or similar to those of the voice assistant system 300 in FIG. 3 or the first example variation 400A in FIG. 4A are given the same reference numbers, and detailed description thereof may be simplified or omitted.

As shown in FIG. 4B, the second example variation 400B may include an LLP subsystem 320B that corresponds to the LLP subsystem 320 in FIG. 3, and a TTS subsystem 330B that corresponds to the TTS subsystem 330 in FIG. 3. As shown in FIG. 4B, the LLP subsystem 320B of the second example variation 400B may include an auxiliary encoder 410 and a response generator 440. In some aspects, the auxiliary encoder 410 may extract and output the input paralinguistic element of the input speech to the response generator 440. In some aspects, the auxiliary encoder 410 may receive the input audio data 302 and may process at least the input audio data 302 to obtain one or more input paralinguistic parameters 412 representing the input paralinguistic element of the input speech. In some aspects, the one or more input paralinguistic parameters 412 may be obtained further based on the one or more sensory inputs 342 from the one or more sensors 340.

In some aspects, the combination of the prompt generator 420 and the response generator 430 in FIG. 4A may be replaced by the response generator 440 in FIG. 4B. In some aspects, the response generator 440 may apply an (adapted) LLM of the LLP subsystem 320B on at least the input text 312 and the one or more input paralinguistic parameters 412 in order to output a response 322B. In some aspects, the response generator 440 may further take a user setting 362, a user profile 352, and/or one or more sensory inputs 342 as inputs. In some aspects, the response 322B may be generated based on applying the LLM of the LLP subsystem 320B further on the user setting 362, the user profile 352, the one or more sensory inputs 342 as inputs, or any combination thereof. In some aspects according to the second example variation 400B, the response 322B may include at least an output text of the output speech and one or more output paralinguistic parameters representing an output paralinguistic element of the output speech.

In some aspects, compared with the LLM used by the response generator 430, the LLM used by the response generator 440 may include one or more added layers for taking the one or more input paralinguistic parameters 412, the input text 312 of the input speech, the user setting 362, the user profile 352, and/or the one or more sensory inputs 342 as inputs and generating the output text and the one or more output paralinguistic parameters as outputs.

In some aspects, the TTS subsystem 330B may be an expressive TTS subsystem. In some aspects, the TTS subsystem 330B may convert the response 322B into the output audio data 332B that corresponds to an output speech of a virtual agent. In some aspects, the one or more output paralinguistic parameters may indicate an emotion cue of the virtual agent. In some aspects, the TTS subsystem 330B may generate the output audio data 332A to present the output speech with a voice tone based on the emotion cue of the virtual agent indicated in the response 322B.

FIG. 4C illustrates a simplified functional block diagram of a third example variation 400C based on the voice assistant system 300 in FIG. 3, according to aspects of the disclosure. In some aspects, the components of the third example variation 400C in FIG. 4C that are the same or similar to those of the voice assistant system 300 in FIG. 3 or the example variations 400A-400B in FIGS. 4A-4B are given the same reference numbers, and detailed description thereof may be simplified or omitted.

As shown in FIG. 4C, the third example variation 400C may include an LLP subsystem 320C that corresponds to the LLP subsystem 320 in FIG. 3, and a TTS subsystem 330C that corresponds to the TTS subsystem 330 in FIG. 3. As shown in FIG. 4C, the LLP subsystem 320C of the third example variation 400C may include an auxiliary encoder 410 and a response generator 440. In some aspects, the auxiliary encoder 410 may process at least the input audio data 302 to obtain one or more input paralinguistic parameters 412 representing the input paralinguistic element of the input speech. In some aspects, the one or more input paralinguistic parameters 412 may be obtained further based on the one or more sensory inputs 342 from the one or more sensors 340.

In some aspects, the response generator 440 may apply an (adapted) LLM of the LLP subsystem 320C on at least the input text 312 and the one or more input paralinguistic parameters 412 in order to output a first part of the response 322C-1 and a second part of the response 322C-2. In some aspects, the first part of the response 322C-1 and the second part of the response 322C-2 may be generated based on applying the LLM of the large language processing subsystem further on the user setting 362, the user profile 352, the one or more sensory inputs 342, or any combination thereof.

In some aspects, the first part of the response 322C-1 may include at least an output text of the output speech. In some aspects, the second part of the response 322C-2 may include one or more output paralinguistic parameters representing an output paralinguistic element of the output speech. In some aspects, the third example variation 400C may further include an expression generator 450 that is configured to generate one or more expression embeddings 452 based on the one or more output paralinguistic parameters included in the second part of the response 322C-2.

In some aspects, the TTS subsystem 330C may be an expressive TTS subsystem. In some aspects, the TTS subsystem 330C may convert the first part of the response 322C-1 and the one or more expression embeddings 452 into the output audio data 332C that corresponds to an output speech of a virtual agent. In some aspects, the expression generator 450 may expand the emotion cue indicated by the second part of the response 322C-2 into detailed settings or operations of the TTS subsystem 330C indicated by the one or more expression embeddings 452 in order to improve the expressive quality of the output speech.

FIG. 4D illustrates a simplified functional block diagram of a fourth example variation 400D based on the voice assistant system 300 in FIG. 3, according to aspects of the disclosure. In some aspects, the components of the fourth example variation 400D in FIG. 4D that are the same or similar to those of the voice assistant system 300 in FIG. 3 or the example variations 400A-400C in FIGS. 4A-4C are given the same reference numbers, and detailed description thereof may be simplified or omitted.

As shown in FIG. 4D, the fourth example variation 400D may include an LLP subsystem 320D that corresponds to the LLP subsystem 320 in FIG. 3, and a TTS subsystem 330D that corresponds to the TTS subsystem 330 in FIG. 3. As shown in FIG. 4D, the LLP subsystem 320D of the fourth example variation 400D may include an auxiliary encoder 410 and a response generator 440. In some aspects, the auxiliary encoder 410 may process at least the input audio data 302 to obtain one or more input paralinguistic parameters 412 representing the input paralinguistic element of the input speech. In some aspects, the one or more input paralinguistic parameters 412 may be obtained further based on the one or more sensory inputs 342 from the one or more sensors 340.

In some aspects, the response generator 440 may apply an (adapted) LLM of the LLP subsystem 320D on at least the input text 312 and the one or more input paralinguistic parameters 412 in order to output a first part of the response 322D-1 and a second part of the response 322D-2. In some aspects, the first part of the response 322D-1 and the second part of the response 322D-2 may be generated based on applying the LLM of the large language processing subsystem further on the user setting 362, the user profile 352, the one or more sensory inputs 342, or any combination thereof.

In some aspects, the first part of the response 322D-1 may include at least an output text of the output speech. In some aspects, the second part of the response 322D-2 may include one or more output paralinguistic parameters representing an output paralinguistic element of the output speech. In some aspects, the fourth example variation 400D may include an expression generator 450 that is configured to generate one or more expression embeddings 452 based on the one or more output paralinguistic parameters included in the second part of the response 322C-2. In some aspects, the one or more expression embeddings 452 may be generated by the expression generator 450 further based on the one or more input paralinguistic parameters 412 from the auxiliary encoder 410.

In some aspects, the TTS subsystem 330D may be an expressive TTS subsystem. In some aspects, the TTS subsystem 330D may convert the first part of the response 322D-1 and the one or more expression embeddings 452 into the output audio data 332D that corresponds to an output speech. In some aspects, the fourth example variation 400D may further include an audio-driven avatar generator 460. In some aspects, the audio-driven avatar generator 460 may receive the output audio data 302 and the one or more expression embeddings 452. In some aspects, the audio-driven avatar generator 460 may generate output display data 462 of an avatar of a virtual agent based on the output audio data 322D of the output speech and the one or more expression embeddings 452. In some aspects, the audio-driven avatar generator 460 may create a more interactive experience for the user based on combination the audio and visual presentations of the avatar of the virtual agent. In some aspects, the output display data 462 may be configured for display in coordination with playback of the output audio data 332D to constitute the audio and visual presentations of the avatar of the virtual agent (e.g., displaying the avatar with a facial expression consistent with the tone or emotion embedded in the output speech).

FIG. 4E illustrates a simplified functional block diagram of a fifth example variation 400E based on the voice assistant system 300 in FIG. 3, according to aspects of the disclosure. In some aspects, the fifth example variation 400E may be deemed as a combination of the first example variation 400A and the fourth example variation 400D. In some aspects, the components of the fifth example variation 400E in FIG. 4E that are the same or similar to those of the voice assistant system 300 in FIG. 3 or the example variations 400A-400D in FIGS. 4A-4D are given the same reference numbers, and detailed description thereof may be simplified or omitted.

As shown in FIG. 4E, the fifth example variation 400E may include an LLP subsystem 320E that corresponds to the LLP subsystem 320 in FIG. 3 and a TTS subsystem 330E that corresponds to the TTS subsystem 330 in FIG. 3. In some aspects, the LLP subsystem 320E may include an auxiliary encoder 410 and a prompt generator 420 as described with reference to FIG. 4A. In some aspects, compared with the prompt generator 420 in FIG. 4A, the prompt generator 420 in FIG. 4E may further receive the input audio data 302 and may generate the prompt 422 further based on the input audio data 302.

In addition, compared with the LLP subsystem 320A in FIG. 4A, the LLP subsystem 320E in FIG. 4E may include a response generator 470 in place of the response generator 430. Compared with the response generator 430 in FIG. 4A, the response generator 470 may apply an (adapted) LLM on the prompt 422 as well as other inputs (e.g., the one or more sensory inputs 342 and/or the one or more input paralinguistic parameters 412). In some aspects, the LLP subsystem 320E may output a first part of the response 322E-1 and a second part of the response 322E-2. In some aspects, the first part of the response 322E-1 may include at least an output text of the output speech. In some aspects, the second part of the response 322E-2 may include one or more output paralinguistic parameters representing an output paralinguistic element of the output speech.

In some aspects, compared with the LLP subsystem 320D in FIG. 4D, the LLP subsystem 320E may further receive the second part of the response 322E-2 and may convert the first part of the response 322E-1, the one or more expression embeddings 452, and/or the second part of the response 322E-2 into the output audio data 332E that corresponds to an output speech.

In some aspects, the fifth example variation 400E may further include an expression generator 450 and an audio-driven avatar generator 460. The operations of the expression generator 450 and the audio-driven avatar generator 460 in FIG. 4E may be the same or similar to the operations of the expression generator 450 and the audio-driven avatar generator 460 in FIG. 4D.

FIG. 4F illustrates a simplified functional block diagram of a sixth example variation 400F based on the voice assistant system 300 in FIG. 3, according to aspects of the disclosure. In some aspects, the sixth example variation 400F may be a variation of the fifth example variation 400E, and the details regarding the LLP subsystem 320E are not depicted in FIG. 4F. In some aspects, the components of the sixth example variation 400F in FIG. 4F that are the same or similar to those of the example variations 400E in FIG. 4E are given the same reference numbers, and detailed description thereof may be simplified or omitted.

Compared with the fifth example variation 400E in FIG. 4E, the sixth example variation 400F may further include an expression controller 480. In some aspects, the expression controller 480 may receive the one or more expression embeddings 452 and a user input 482. In some aspects, the expression controller 480 may adjust the one or more expression embeddings 452 to become one or more adjusted expression embeddings 484. In some aspects, the output display data 462 may be generated by the audio-driven avatar generator 460 based on the one or more adjusted expression embeddings 484. In some aspects, the output audio data 332E may be generated by the expressive text-to-speech subsystem 330E based on the output text and the one or more adjusted expression embeddings 484.

The sixth example variation 400F is illustrated based on inserting the expression controller 480 between the expression generator 450 and the TTS subsystem 330E and/or the audio-driven avatar generator 460 in FIG. 4E. In some aspects, the third example variation 400C may be modified based on inserting the expression controller 480 between the expression generator 450 and the TTS subsystem 330C in FIG. 4C. In some aspects, the fourth example variation 400D may be modified based on inserting the expression controller 480 between the expression generator 450 and the TTS subsystem 330D and/or the audio-driven avatar generator 460 in FIG. 4D.

In some aspects, the voice assistant system and variations illustrated in FIGS. 4A-4F may be implemented based on one or more processing devices. In some aspects, if the voice assistant system is implemented based multiple processing devices, these processing devices may communicate with one another via a wired communication or a wireless communication to exchange information, data, and/or parameters as illustrated herein.

Taking the variation 400E in FIG. 4E as an example, all the functional blocks illustrated in FIG. 4E may be implemented in a processing device, such as a UE, a handheld computing device, or a laptop computer, according to some examples. Also, in some other examples, the ASR subsystem 310, the sensors 340, the TTS subsystem 330E, the expression generator 450, and the audio-driven avatar generator 460 may be implemented by a UE; and the LLP subsystem 320E may be implemented by another UE or a server device. In yet some other examples, the prompt generator 420, the auxiliary encoder 410, the TTS subsystem 330E, and the audio-driven avatar generator 460 may be implemented by a UE; and the ASR subsystem 310, the LLP subsystem 320E, and the expression generator 450 may be implemented by another UE or a server device.

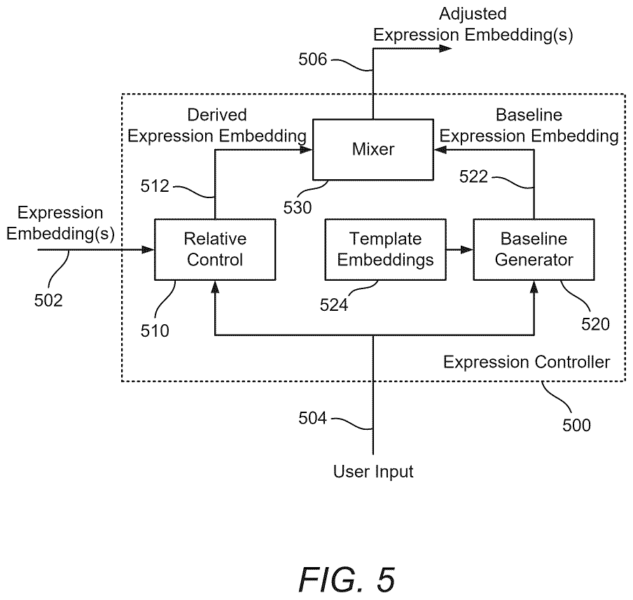

FIG. 5 illustrates a simplified functional block diagram of an example expression controller 500, according to aspects of the disclosure. In some aspects, the expression controller 500 may correspond to the expression controller 480 in FIG. 4F.

As shown in FIG. 5, the expression controller 500 may receive one or more expression embeddings 502 (which may correspond to the one or more expression embeddings 452 in FIG. 4F) and a user input 504 (which may correspond to the user input 482 in FIG. 4F). The expression controller 500 may adjust the one or more expression embeddings 502 to obtain one or more adjusted expression embeddings 506 (which may correspond to the one or more adjusted expression embeddings 484 in FIG. 4F) based on the user input 504. In some aspects, the expression controller 500 may receive the user input 504 that is provided via a user interface (e.g., a control knob) of a processing device that is used to implement a portion or all of a voice assistant system as illustrated in FIGS. 3-4F.

In some aspects, the expression controller 500 may include a relative control 510 configured to apply a relative adjustment on the one or more expression embeddings 502 based on the user input 504 to obtain one or more derived expression embeddings 512. For example, the relative control 510 may enhance the happiness element or an anger element of the one or more expression embeddings 502 based on the user input 504.

In some aspects, the expression controller 500 may include a baseline generator 520 configured to generate one or more baseline expression embeddings 522 based on the user input 504 and one or more template embeddings 524 stored in or accessible to the expression controller 500. For example, the baseline generator 520 may select a subset of the one or more template embeddings 524 that correspond to a more motivative emotion setting based on the user input 504.

In some aspects, the expression controller 500 may further include a mixer 530 configured to generate the one or more adjusted expression embeddings 506 based on applying a mixing function on the one or more derived expression embeddings 512 and the one or more baseline expression embeddings 522.

In some aspects, the expression controller 500, through adjusting the expression embeddings, may be used to conceal or enhance the emotion of the virtual agent (such as showing less negative emotions or more positive emotions), enhance the audio and video of the virtual agent to be more or less expressive or persuasive, and/or reflect the settings regarding the personality and the identity of the virtual agent.

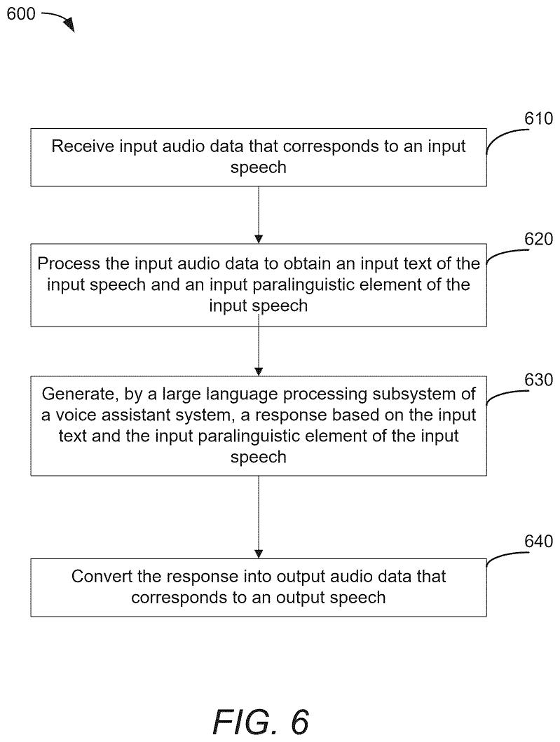

FIG. 6 is a flowchart illustrating a method 600 of operating a voice assistant system, according to aspects of the disclosure. In some aspects, the voice assistant system may correspond to the voice assistant system 300 in FIG. 3 or any of the variations 400A-400F in FIGS. 4A-4F. In some aspects, the voice assistant system may be implemented based on one or more processing devices.

In some aspects, at least a portion of the voice assistant system in the method 600 may be implemented based on a UE, such as the UE 202 in FIG. 2A; and at least a portion of the method 600 may be performed by the one or more processors 242, the memory 240, and/or the voice assistant component 248, any or all of which may be considered means for performing one or more of the following operations of method 600. In some aspects, at least a portion of the voice assistant system in the method 600 may be implemented based on a server device, such as the server device 206 in FIG. 2B; and the method 600 may be performed by the one or more processors 294, the memory 296, and/or the voice assistant component 298, any or all of which may be considered means for performing one or more of the following operations of method 600.

At operation 610, the voice assistant system (e.g., the voice assistant system 300 in FIG. 3 or any of the variations 400A-400F in FIGS. 4A-4F) may receive input audio data that corresponds to an input speech. In some aspects, operation 610 may be performed by the one or more processors 242, the memory 240, and/or the voice assistant component 248, any or all of which may be considered means for performing operation 610. In some aspects, operation 610 may be performed by the one or more processors 294, the memory 296, and/or the voice assistant component 298, any or all of which may be considered means for performing operation 610.

At operation 620, the voice assistant system may process the input audio data to obtain an input text of the input speech (e.g., by an ASR subsystem 310 of the voice assistant system in FIGS. 4A-4F) and an input paralinguistic element of the input speech (e.g., by an auxiliary encoder 410 in FIGS. 4A-4E). In some aspects, at operation 620, the auxiliary encoder may process at least the input audio data to obtain one or more input paralinguistic parameters representing the input paralinguistic element of the input speech. In some aspects, operation 620 may be performed by the one or more processors 242, the memory 240, and/or the voice assistant component 248, any or all of which may be considered means for performing operation 620. In some aspects, operation 620 may be performed by the one or more processors 294, the memory 296, and/or the voice assistant component 298, any or all of which may be considered means for performing operation 620.

At operation 630, an LLP subsystem of the voice assistant system may generate a response based on the input text and the input paralinguistic element of the input speech. In some aspects, operation 630 may be performed by the one or more processors 242, the memory 240, and/or the voice assistant component 248, any or all of which may be considered means for performing operation 630. In some aspects, operation 630 may be performed by the one or more processors 294, the memory 296, and/or the voice assistant component 298, any or all of which may be considered means for performing operation 630.

In some aspects, at operation 630, a prompt generator of the large language processing subsystem (e.g., the prompt generator 420 in FIGS. 4A and 4E), may generate a prompt based on the input text and the one or more input paralinguistic parameters. In some aspects, the response may be generated based on applying a large language model of the large language processing subsystem on at least the prompt (e.g., by the response generator 430 in FIGS. 4A and 4E). In some aspects, the response may include at least an output text of the output speech.

In some aspects, the prompt generator may include a learning logic or a machine learning model. In some aspects, the prompt may be generated by the prompt generator further based on a user setting, a user profile, one or more sensory inputs, or any combination thereof.

In some aspects, the response may be generated based on applying a large language model of the large language processing subsystem on at least the input text and the one or more input paralinguistic parameters (e.g., by the response generator 440 in FIGS. 4B-4D). In some aspects, the response may be generated based on applying the large language model of the large language processing subsystem further on a user setting, a user profile, one or more sensory inputs, or any combination thereof.

In some aspects, the response may include at least an output text of the output speech. In some aspects, the response may further include one or more output paralinguistic parameters representing an output paralinguistic element of the output speech. In some aspects, the converting the response into the output audio data of the output speech may be performed by an expressive text-to-speech subsystem of the voice assistant system (e.g., the TTS subsystem 330B in FIG. 4B) based on the output text and the one or more output paralinguistic parameters

In some aspects, the method 600 may further include generating, by an expression generator of the voice assistant system (e.g., the expression generator 450 in FIGS. 4C-4E), one or more expression embeddings based on the one or more output paralinguistic parameters. In some aspects, the converting the response into the output audio data of the output speech may be performed by an expressive text-to-speech subsystem (e.g., the TTS subsystem 330C, 330D, or 330E in FIGS. 4C-4E) based on the output text and the one or more expression embeddings.

In some aspects, an expression generator of the voice assistant system (e.g., the expression generator 450 in FIGS. 4D-4E) may generate one or more expression embeddings based on the one or more input paralinguistic parameters, one or more output paralinguistic parameters derived based on the one or more input paralinguistic parameters, or both.

At operation 640, the voice assistant system (e.g., the TTS subsystem 330A-330E in FIGS. 4A-4F) may convert the response into output audio data that corresponds to an output speech. In some aspects, operation 640 may be performed by the one or more processors 242, the memory 240, and/or the voice assistant component 248, any or all of which may be considered means for performing operation 640. In some aspects, operation 640 may be performed by the one or more processors 294, the memory 296, and/or the voice assistant component 298, any or all of which may be considered means for performing operation 640.

In some aspects, the method 600 may further include generating, by an audio-driven avatar generator of the voice assistant system (e.g., the audio-driven avatar generator 460 in FIGS. 4D-4F), output display data of an avatar of a virtual agent based on the output audio data of the output speech and the one or more expression embeddings. In some aspects, the output display data may be configured for display in coordination with playback of the output audio data.

In some aspects, the method 600 may further include adjusting, by an expression controller of the voice assistant system (e.g., the expression controller 480 in FIG. 4F), the one or more expression embeddings to become one or more adjusted expression embeddings. In some aspects, the response includes at least an output text of the output speech. In some aspects, the output display data may be generated by the audio-driven avatar generator based on the one or more adjusted expression embeddings. In some aspects, the output audio data may be generated by an expressive text-to-speech subsystem of the voice assistant system (e.g., the TTS subsystem 330E in FIG. 4F) based on the output text and the one or more adjusted expression embeddings.

In some aspects, the adjusting, by the expression controller, the one or more expression embeddings may include applying a relative adjustment on the one or more expression embeddings based on a user input to obtain one or more derived expression embeddings, generating one or more baseline expression embeddings based on the user input and one or more template embeddings, and generating the one or more adjusted expression embeddings based on applying a mixing function on the one or more derived expression embeddings and the one or more baseline expression embeddings.

As will be appreciated, a technical advantage of the method 600 is generating a response by applying a large language model of a voice assistant system on at least an input text of an input speech and an input paralinguistic element (e.g., mood, emotion, or intent) of the input speech. In some aspects, the response may include an output text of an output speech and information corresponding to an output paralinguistic element (e.g., expression, emotion, or tone) of the output speech. Accordingly, a user of the voice assistant system may interact with the voice assistant system as if the user is interacting with a virtual agent resembling the experiences of talking to a real person.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A voice assistant system, comprising: one or more processing devices configured to: receive input audio data that corresponds to an input speech; and process the input audio data to obtain an input text of the input speech and an input paralinguistic element of the input speech; and a large language processing subsystem configured to: generate a response based on the input text and the input paralinguistic element of the input speech, wherein the one or more processing devices are further configured to: convert the response into output audio data that corresponds to an output speech.

Clause 2. The voice assistant system of clause 1, wherein the large language processing subsystem comprises: an auxiliary encoder configured to process at least the input audio data to obtain one or more input paralinguistic parameters representing the input paralinguistic element of the input speech; and a prompt generator configured to generate a prompt based on the input text and the one or more input paralinguistic parameters, wherein: the response is generated based on applying a large language model of the large language processing subsystem on at least the prompt, and the response includes at least an output text of the output speech.

Clause 3. The voice assistant system of clause 2, wherein the prompt generator includes a learning logic or a machine learning model.

Clause 4. The voice assistant system of any of clauses 2 to 3, further comprising a user interface configured to display the prompt generated by the prompt generator.

Clause 5. The voice assistant system of any of clauses 2 to 4, further comprising a user interface configured to obtain a user profile, wherein the prompt generator is configured to generate the prompt further based on the user profile.

Clause 6. The voice assistant system of any of clauses 2 to 5, further comprising one or more sensors configured to obtain one or more sensory inputs, wherein the prompt generator is configured to generate the prompt further based on the one or more sensory inputs.

Clause 7. The voice assistant system of any of clauses 1 to 6, wherein the large language processing subsystem comprises: an auxiliary encoder configured to obtain one or more input paralinguistic parameters representing the input paralinguistic element of the input speech, wherein: the response is generated based on applying a large language model of the large language processing subsystem on at least the input text and the one or more input paralinguistic parameters, and the response includes at least an output text of the output speech.

Clause 8. The voice assistant system of clause 7, wherein the response is generated based on applying the large language model of the large language processing subsystem further on: a user setting, a user profile, one or more sensory inputs, or any combination thereof.

Clause 9. The voice assistant system of any of clauses 7 to 8, wherein the response further includes one or more output paralinguistic parameters representing an output paralinguistic element of the output speech.

Clause 10. The voice assistant system of clause 9, wherein the one or more processing devices comprise: an expressive text-to-speech subsystem configured to convert the response into the output audio data of the output speech based on the output text and the one or more output paralinguistic parameters.

Clause 11. The voice assistant system of any of clauses 9 to 10, wherein the one or more processing devices comprise: an expression generator configured to generate one or more expression embeddings based on the one or more output paralinguistic parameters; and an expressive text-to-speech subsystem configured to convert the response into the output audio data of the output speech based on the output text and the one or more expression embeddings.

Clause 12. The voice assistant system of any of clauses 1 to 11, wherein the one or more processing devices comprise: an auxiliary encoder configured to obtain one or more input paralinguistic parameters representing the input paralinguistic element of the input speech; an expression generator configured to generate one or more expression embeddings based on the one or more input paralinguistic parameters, one or more output paralinguistic parameters derived based on the one or more input paralinguistic parameters, or both; and an audio-driven avatar generator configured to generate output display data of an avatar of a virtual agent based on the output audio data of the output speech and the one or more expression embeddings, the output display data being configured for display in coordination with playback of the output audio data.

Clause 13. The voice assistant system of clause 12, wherein the large language processing subsystem comprises: a prompt generator configured to generate a prompt based on the input text and the one or more input paralinguistic parameters, wherein: the response is generated based on applying a large language model of the large language processing subsystem on at least the prompt, or based on at least the prompt and the one or more input paralinguistic parameters, and the response includes at least an output text of the output speech or at least the output text of the output speech and the one or more output paralinguistic parameters.

Clause 14. The voice assistant system of any of clauses 12 to 13, wherein the one or more processing devices comprise: an expression controller configured to adjust the one or more expression embeddings to become one or more adjusted expression embeddings, wherein: the response includes at least an output text of the output speech, the output display data is generated by the audio-driven avatar generator based on the one or more adjusted expression embeddings, and the output audio data is generated by an expressive text-to-speech subsystem of the voice assistant system based on the output text and the one or more adjusted expression embeddings.

Clause 15. The voice assistant system of clause 14, wherein the expression controller configured to adjust the one or more expression embeddings is further configured to:

apply a relative adjustment on the one or more expression embeddings based on a user input to obtain one or more derived expression embeddings; generate one or more baseline expression embeddings based on the user input and one or more template embeddings; and generate the one or more adjusted expression embeddings based on applying a mixing function on the one or more derived expression embeddings and the one or more baseline expression embeddings.

Clause 16. The voice assistant system of any of clauses 1 to 15, further comprising one or more microphones configured to capture the input audio data that corresponds to the input speech.

Clause 17. A method of operating a voice assistant system on one or more processing devices, the method comprising: receiving input audio data that corresponds to an input speech; processing the input audio data to obtain an input text of the input speech and an input paralinguistic element of the input speech; generating, by a large language processing subsystem of the voice assistant system, a response based on the input text and the input paralinguistic element of the input speech; and converting the response into output audio data that corresponds to an output speech.

Clause 18. The method of clause 17, further comprising: processing, by an auxiliary encoder of the large language processing subsystem, at least the input audio data to obtain one or more input paralinguistic parameters representing the input paralinguistic element of the input speech; and generating, by a prompt generator of the large language processing subsystem, a prompt based on the input text and the one or more input paralinguistic parameters, wherein: the response is generated based on applying a large language model of the large language processing subsystem on at least the prompt, and the response includes at least an output text of the output speech.

Clause 19. The method of clause 18, wherein the prompt generator includes a learning logic or a machine learning model.

Clause 20. The method of any of clauses 18 to 19, wherein the prompt is generated by the prompt generator further based on: a user setting, a user profile, one or more sensory inputs, or any combination thereof.

Clause 21. The method of any of clauses 17 to 20, further comprising: obtaining, by an auxiliary encoder of the large language processing subsystem, one or more input paralinguistic parameters representing the input paralinguistic element of the input speech, wherein: the response is generated based on applying a large language model of the large language processing subsystem on at least the input text and the one or more input paralinguistic parameters, and the response includes at least an output text of the output speech.

Clause 22. The method of clause 21, wherein the response is generated based on applying the large language model of the large language processing subsystem further on: a user setting, a user profile, one or more sensory inputs, or any combination thereof.

Clause 23. The method of any of clauses 21 to 22, wherein the response further includes one or more output paralinguistic parameters representing an output paralinguistic element of the output speech.

Clause 24. The method of clause 23, wherein the converting the response into the output audio data of the output speech is performed by an expressive text-to-speech subsystem of the voice assistant system based on the output text and the one or more output paralinguistic parameters.

Clause 25. The method of any of clauses 23 to 24, further comprising: generating, by an expression generator of the voice assistant system, one or more expression embeddings based on the one or more output paralinguistic parameters, wherein the converting the response into the output audio data of the output speech is performed by an expressive text-to-speech subsystem based on the output text and the one or more expression embeddings.

Clause 26. The method of any of clauses 17 to 25, further comprising: obtaining, by an auxiliary encoder of the large language processing subsystem, one or more input paralinguistic parameters representing the input paralinguistic element of the input speech; generating, by an expression generator of the voice assistant system, one or more expression embeddings based on the one or more input paralinguistic parameters, one or more output paralinguistic parameters derived based on the one or more input paralinguistic parameters, or both; and generating, by an audio-driven avatar generator of the voice assistant system, output display data of an avatar of a virtual agent based on the output audio data of the output speech and the one or more expression embeddings, the output display data being configured for display in coordination with playback of the output audio data.

Clause 27. The method of clause 26, further comprising: generating, by a prompt generator of the large language processing subsystem, a prompt based on the input text and the one or more input paralinguistic parameters, wherein: the response is generated based on applying a large language model of the large language processing subsystem on at least the prompt, or based on at least the prompt and the one or more input paralinguistic parameters, and the response includes at least an output text of the output speech or at least the output text of the output speech and the one or more output paralinguistic parameters.

Clause 28. The method of any of clauses 26 to 27, further comprising: adjusting, by an expression controller of the voice assistant system, the one or more expression embeddings to become one or more adjusted expression embeddings, wherein: the response includes at least an output text of the output speech, the output display data is generated by the audio-driven avatar generator based on the one or more adjusted expression embeddings, and the output audio data is generated by an expressive text-to-speech subsystem of the voice assistant system based on the output text and the one or more adjusted expression embeddings.

Clause 29. The method of clause 28, wherein the adjusting, by the expression controller, the one or more expression embeddings comprises: applying a relative adjustment on the one or more expression embeddings based on a user input to obtain one or more derived expression embeddings; generating one or more baseline expression embeddings based on the user input and one or more template embeddings; and generating the one or more adjusted expression embeddings based on applying a mixing function on the one or more derived expression embeddings and the one or more baseline expression embeddings.

Clause 30. A voice assistant system, comprising: means for receiving input audio data that corresponds to an input speech; means for processing the input audio data to obtain an input text of the input speech and an input paralinguistic element of the input speech; means for generating a response based on the input text and the input paralinguistic element of the input speech; and means for converting the response into output audio data that corresponds to an output speech.

Clause 31. The voice assistant system of clause 30, wherein the means for generating the response comprises: means for processing at least the input audio data to obtain one or more input paralinguistic parameters representing the input paralinguistic element of the input speech; and means for generating a prompt based on the input text and the one or more input paralinguistic parameters, wherein: the response is generated based on applying a large language model on at least the prompt, and the response includes at least an output text of the output speech.

Clause 32. The voice assistant system of clause 31, wherein the means for generating the prompt includes a learning logic or a machine learning model.

Clause 33. The voice assistant system of any of clauses 31 to 32, wherein the prompt is generated by the means for generating a prompt further based on: a user setting, a user profile, one or more sensory inputs, or any combination thereof.

Clause 34. The voice assistant system of any of clauses 30 to 33, further comprising: means for obtaining one or more input paralinguistic parameters representing the input paralinguistic element of the input speech, wherein: the response is generated based on applying a large language model on at least the input text and the one or more input paralinguistic parameters, and the response includes at least an output text of the output speech.

Clause 35. The voice assistant system of clause 34, wherein the response is generated based on applying the large language model further on: a user setting, a user profile, one or more sensory inputs, or any combination thereof.

Clause 36. The voice assistant system of any of clauses 34 to 35, wherein the response further includes one or more output paralinguistic parameters representing an output paralinguistic element of the output speech.

Clause 37. The voice assistant system of clause 36, wherein the means for converting the response into the output audio data of the output speech is based on the output text and the one or more output paralinguistic parameters.

Clause 38. The voice assistant system of any of clauses 36 to 37, further comprising: means for generating one or more expression embeddings based on the one or more output paralinguistic parameters, wherein the means for converting the response into the output audio data of the output speech is based on the output text and the one or more expression embeddings.

Clause 39. The voice assistant system of any of clauses 30 to 38, further comprising: means for obtaining one or more input paralinguistic parameters representing the input paralinguistic element of the input speech; means for generating one or more expression embeddings based on the one or more input paralinguistic parameters, one or more output paralinguistic parameters derived based on the one or more input paralinguistic parameters, or both; and means for generating output display data of an avatar of a virtual agent based on the output audio data of the output speech and the one or more expression embeddings, the output display data being configured for display in coordination with playback of the output audio data.

Clause 40. The voice assistant system of clause 39, further comprising: means for generating a prompt based on the input text and the one or more input paralinguistic parameters, wherein: the response is generated based on applying a large language model on at least the prompt, or based on at least the prompt and the one or more input paralinguistic parameters, and the response includes at least an output text of the output speech or at least the output text of the output speech and the one or more output paralinguistic parameters.

Clause 41. The voice assistant system of any of clauses 39 to 40, further comprising: means for adjusting the one or more expression embeddings to become one or more adjusted expression embeddings, wherein: the response includes at least an output text of the output speech, the output display data is generated based on the one or more adjusted expression embeddings, and the output audio data is generated based on the output text and the one or more adjusted expression embeddings.

Clause 42. The voice assistant system of clause 41, wherein the means for adjusting the one or more expression embeddings comprises: means for applying a relative adjustment on the one or more expression embeddings based on a user input to obtain one or more derived expression embeddings; means for generating one or more baseline expression embeddings based on the user input and one or more template embeddings; and means for generating the one or more adjusted expression embeddings based on applying a mixing function on the one or more derived expression embeddings and the one or more baseline expression embeddings.

Clause 43. A non-transitory computer-readable medium storing computer-executable instructions that, when executed by a voice assistant system, cause the voice assistant system to: receive input audio data that corresponds to an input speech; process the input audio data to obtain an input text of the input speech and an input paralinguistic element of the input speech; generate a response based on the input text and the input paralinguistic element of the input speech; and convert the response into output audio data that corresponds to an output speech.

Clause 44. The non-transitory computer-readable medium of clause 43, further comprising computer-executable instructions that, when executed by the voice assistant system, cause the voice assistant system to: process at least the input audio data to obtain one or more input paralinguistic parameters representing the input paralinguistic element of the input speech; and generate a prompt based on the input text and the one or more input paralinguistic parameters, wherein: the response is generated based on applying a large language model on at least the prompt, and the response includes at least an output text of the output speech.

Clause 45. The non-transitory computer-readable medium of clause 44, wherein the prompt is generated further based on: a user setting, a user profile, one or more sensory inputs, or any combination thereof.

Clause 46. The non-transitory computer-readable medium of any of clauses 43 to 45, further comprising computer-executable instructions that, when executed by the voice assistant system, cause the voice assistant system to: obtain one or more input paralinguistic parameters representing the input paralinguistic element of the input speech, wherein: the response is generated based on applying a large language model on at least the input text and the one or more input paralinguistic parameters, and the response includes at least an output text of the output speech.

Clause 47. The non-transitory computer-readable medium of clause 46, wherein the response is generated based on applying the large language model further on: a user setting, a user profile, one or more sensory inputs, or any combination thereof.

Clause 48. The non-transitory computer-readable medium of any of clauses 46 to 47, wherein the response further includes one or more output paralinguistic parameters representing an output paralinguistic element of the output speech.

Clause 49. The non-transitory computer-readable medium of clause 48, wherein the response is converted into the output audio data of the output speech based on the output text and the one or more output paralinguistic parameters.

Clause 50. The non-transitory computer-readable medium of any of clauses 48 to 49, further comprising computer-executable instructions that, when executed by the voice assistant system, cause the voice assistant system to: generate one or more expression embeddings based on the one or more output paralinguistic parameters, wherein the response is converted into the output audio data of the output speech based on the output text and the one or more expression embeddings.

Clause 51. The non-transitory computer-readable medium of any of clauses 43 to 50, further comprising computer-executable instructions that, when executed by the voice assistant system, cause the voice assistant system to: obtain one or more input paralinguistic parameters representing the input paralinguistic element of the input speech; generate one or more expression embeddings based on the one or more input paralinguistic parameters, one or more output paralinguistic parameters derived based on the one or more input paralinguistic parameters, or both; and generate output display data of an avatar of a virtual agent based on the output audio data of the output speech and the one or more expression embeddings, the output display data being configured for display in coordination with playback of the output audio data.

Clause 52. The non-transitory computer-readable medium of clause 51, further comprising computer-executable instructions that, when executed by the voice assistant system, cause the voice assistant system to: generate a prompt based on the input text and the one or more input paralinguistic parameters, wherein: the response is generated based on applying a large language model on at least the prompt, or based on at least the prompt and the one or more input paralinguistic parameters, and the response includes at least an output text of the output speech or at least the output text of the output speech and the one or more output paralinguistic parameters.

Clause 53. The non-transitory computer-readable medium of any of clauses 51 to 52, further comprising computer-executable instructions that, when executed by the voice assistant system, cause the voice assistant system to: adjust the one or more expression embeddings to become one or more adjusted expression embeddings, wherein: the response includes at least an output text of the output speech, the output display data is generated based on the one or more adjusted expression embeddings, and the output audio data is generated based on the output text and the one or more adjusted expression embeddings.

Clause 54. The non-transitory computer-readable medium of clause 53, wherein the computer-executable instructions that, when executed by the voice assistant system, cause the voice assistant system to adjust the one or more expression embeddings comprises computer-executable instructions that, when executed by the voice assistant system, cause the voice assistant system to: apply a relative adjustment on the one or more expression embeddings based on a user input to obtain one or more derived expression embeddings; generate one or more baseline expression embeddings based on the user input and one or more template embeddings; and generate the one or more adjusted expression embeddings based on applying a mixing function on the one or more derived expression embeddings and the one or more baseline expression embeddings.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A voice assistant system, comprising:
one or more processing devices configured to:
receive input audio data that corresponds to an input speech; and
process the input audio data to obtain an input text of the input speech and an input paralinguistic element of the input speech; and
a large language processing subsystem configured to:
generate a response based on the input text and the input paralinguistic element of the input speech,
wherein the one or more processing devices are further configured to:
convert the response into output audio data that corresponds to an output speech.

2. The voice assistant system of claim 1, wherein the large language processing subsystem comprises:
an auxiliary encoder configured to process at least the input audio data to obtain one or more input paralinguistic parameters representing the input paralinguistic element of the input speech; and
a prompt generator configured to generate a prompt based on the input text and the one or more input paralinguistic parameters,
wherein:
the response is generated based on applying a large language model of the large language processing subsystem on at least the prompt, and
the response includes at least an output text of the output speech.

3. The voice assistant system of claim 2, wherein the prompt generator includes a learning logic or a machine learning model.

4. The voice assistant system of claim 2, further comprising a user interface configured to display the prompt generated by the prompt generator.

5. The voice assistant system of claim 2, further comprising a user interface configured to obtain a user profile,
wherein the prompt generator is configured to generate the prompt further based on the user profile.

6. The voice assistant system of claim 2, further comprising one or more sensors configured to obtain one or more sensory inputs,
wherein the prompt generator is configured to generate the prompt further based on the one or more sensory inputs.

7. The voice assistant system of claim 1, wherein the large language processing subsystem comprises:
an auxiliary encoder configured to obtain one or more input paralinguistic parameters representing the input paralinguistic element of the input speech,
wherein:
the response is generated based on applying a large language model of the large language processing subsystem on at least the input text and the one or more input paralinguistic parameters, and
the response includes at least an output text of the output speech.

8. The voice assistant system of claim 7, wherein the response is generated based on applying the large language model of the large language processing subsystem further on:
a user setting,
a user profile,
one or more sensory inputs, or
any combination thereof.

9. The voice assistant system of claim 7, wherein the response further includes one or more output paralinguistic parameters representing an output paralinguistic element of the output speech.

10. The voice assistant system of claim 9, wherein the one or more processing devices comprise:
an expressive text-to-speech subsystem configured to convert the response into the output audio data of the output speech based on the output text and the one or more output paralinguistic parameters.

11. The voice assistant system of claim 9, wherein the one or more processing devices comprise:
an expression generator configured to generate one or more expression embeddings based on the one or more output paralinguistic parameters; and
an expressive text-to-speech subsystem configured to convert the response into the output audio data of the output speech based on the output text and the one or more expression embeddings.

12. The voice assistant system of claim 1, wherein the one or more processing devices comprise:
an auxiliary encoder configured to obtain one or more input paralinguistic parameters representing the input paralinguistic element of the input speech;
an expression generator configured to generate one or more expression embeddings based on the one or more input paralinguistic parameters, one or more output paralinguistic parameters derived based on the one or more input paralinguistic parameters, or both; and
an audio-driven avatar generator configured to generate output display data of an avatar of a virtual agent based on the output audio data of the output speech and the one or more expression embeddings, the output display data being configured for display in coordination with playback of the output audio data.

13. The voice assistant system of claim 12, wherein the one or more processing devices comprise:
an expression controller configured to adjust the one or more expression embeddings to become one or more adjusted expression embeddings,
wherein:
the response includes at least an output text of the output speech,
the output display data is generated by the audio-driven avatar generator based on the one or more adjusted expression embeddings, and
the output audio data is generated by an expressive text-to-speech subsystem of the voice assistant system based on the output text and the one or more adjusted expression embeddings.

14. The voice assistant system of claim 13, wherein the expression controller configured to adjust the one or more expression embeddings is further configured to:
apply a relative adjustment on the one or more expression embeddings based on a user input to obtain one or more derived expression embeddings;
generate one or more baseline expression embeddings based on the user input and one or more template embeddings; and
generate the one or more adjusted expression embeddings based on applying a mixing function on the one or more derived expression embeddings and the one or more baseline expression embeddings.

15. The voice assistant system of claim 1, further comprising one or more microphones configured to capture the input audio data that corresponds to the input speech.

16. A non-transitory computer-readable medium storing computer-executable instructions that, when executed by a voice assistant system, cause the voice assistant system to:
receive input audio data that corresponds to an input speech;
process the input audio data to obtain an input text of the input speech and an input paralinguistic element of the input speech;
generate a response based on the input text and the input paralinguistic element of the input speech; and
convert the response into output audio data that corresponds to an output speech.

17. The non-transitory computer-readable medium of claim 16, further comprising computer-executable instructions that, when executed by the voice assistant system, cause the voice assistant system to:
process at least the input audio data to obtain one or more input paralinguistic parameters representing the input paralinguistic element of the input speech; and
generate a prompt based on the input text and the one or more input paralinguistic parameters,
wherein:
the response is generated based on applying a large language model on at least the prompt, and
the response includes at least an output text of the output speech.

18. The non-transitory computer-readable medium of claim 16, further comprising computer-executable instructions that, when executed by the voice assistant system, cause the voice assistant system to:
obtain one or more input paralinguistic parameters representing the input paralinguistic element of the input speech,
wherein:
the response is generated based on applying a large language model on at least the input text and the one or more input paralinguistic parameters, and
the response includes at least an output text of the output speech.

19. The non-transitory computer-readable medium of claim 16, further comprising computer-executable instructions that, when executed by the voice assistant system, cause the voice assistant system to:
obtain one or more input paralinguistic parameters representing the input paralinguistic element of the input speech;
generate one or more expression embeddings based on the one or more input paralinguistic parameters, one or more output paralinguistic parameters derived based on the one or more input paralinguistic parameters, or both; and
generate output display data of an avatar of a virtual agent based on the output audio data of the output speech and the one or more expression embeddings, the output display data being configured for display in coordination with playback of the output audio data.

20. A method of operating a voice assistant system on one or more processing devices, the method comprising:
receiving input audio data that corresponds to an input speech;
processing the input audio data to obtain an input text of the input speech and an input paralinguistic element of the input speech;
generating, by a large language processing subsystem of the voice assistant system, a response based on the input text and the input paralinguistic element of the input speech; and
converting the response into output audio data that corresponds to an output speech.
